(19) United States
(12) Patent Application Publication
(10) Pub. No.: US 2016/0230779 A1
(43) Pub. Date: Aug. 11, 2016

(54) Cartridge for a Pneumatic Circuit and Suction Gripper Device Comprising such a Cartridge

(71) Applicant: COVAL, Montelier (FR)

(72) Inventors: Pierre MILHAU, Bourg De Peage (FR); Michel CECCHIN, Montelier (FR); Loic JOGUET, Guilherand-Granges (FR)

(21) Appl. No.: 15/023,631

(22) PCT Filed: Sep. 5, 2014
(86) PCT No.: PCT/EP2014/068991

§ 371 Date: Apr. 27, 2016

(30) Foreign Application Priority Data
Sep. 23, 2013 (FR) 1359133
Jun. 16, 2014 (FR) 1455511

(51) Int. Cl. F04F 5/20

(52) U.S. Cl. CPC F04F 5/20; B25J 15/0616

(57) ABSTRACT

A cartridge which includes a tubular body having a cylindrical surface enabling it to be inserted in a cylindrical housing in an axial direction (X), the cartridge being such that, in the tubular body, the following are integrated coaxially with one another:
electrical connection method;
control method;
a first chamber which includes a first lateral orifice for admitting compressed air;
at least a second chamber situated at a second end of the tubular body and including an air outlet orifice.
   the control method being suitable for selectively putting the first chamber and the second chamber in pneumatic communication so as to allow passage of air to the second chamber.

The invention relates to a cartridge for a pneumatic circuit that can be used in particular as a vacuum generator. The invention further relates to a sucker gripping device comprising such a cartridge.

### BACKGROUND TO THE INVENTION

Vacuum generators are used in many industrial fields (the automobile industry, pharmaceutics, etc), for example for applications in manipulating or gripping products in a production line.

Two major families of vacuum generator are mainly used: electrical vacuum generators (vacuum pumps) and pneumatic vacuum generators.

A pneumatic vacuum generator functions using the venturi effect. It comprises at least one chamber comprising a nozzle through which compressed air flows, the vacuum generated resulting from a negative pressure created by venturi effect in said chamber. This chamber is put in pneumatic communication with one or more suckers applied to the surface of the product. The vacuum generator aspirates the air contained in the internal space of these suckers and secures the latter to the surface of said product when the suckers are applied against said surface. This allows manipulation or gripping of the product. The vacuum generator is just as often suitable for blowing air into the internal space of the suckers in order to disconnect them from the product once the manipulation or gripping has ended.

The users of pneumatic vacuum generators are not themselves generally specialists in vacuum generation technology: it is therefore important to design generators where the integration thereof in a production line does not require complex operations (pneumatic connections, control of impermeability, etc). To facilitate such integration, it is also advantageous to enable the users to easily adapt the external form of these vacuum generators to their applications and to their products, so as to optimise integration thereof in the production line. Finally, it is desirable to reduce the cost of such integration in order to make vacuum generation technology attractive.

### SUBJECT MATTER OF THE INVENTION

The aim of the invention is to simplify the integration of a vacuum generator in a production line and to reduce the cost of such integration.

### SUMMARY OF THE INVENTION

With a view to achieving this aim, a cartridge is proposed for a pneumatic circuit comprising a tubular body having a cylindrical surface enabling it to be inserted in a cylindrical housing in an axial direction, the cartridge being such that, in said tubular body, the following are integrated coaxially with one another:
electrical connection means situated at a first end of the tubular body;
control means supplied and controlled via the electrical connection means;
a first chamber comprising a first lateral orifice for admitting compressed air;
at least a second chamber situated at a second end of the tubular body and comprising an air outlet orifice.

The means for controlling the cartridge are suitable for selectively putting the first chamber and the second chamber in pneumatic communication so as to allow passage of air to the second chamber.

Such a cartridge for a pneumatic circuit can easily be integrated in a vacuum generator by the User Of this generator, who merely needs to design in the generator a cylindrical housing for inserting the cartridge. This integration therefore does not require the user to have advance knowledge in vacuum generation technology. Moreover, it is relatively simple for the user to design a generator, the external form of which corresponds perfectly to a particular need, since the sole structural constraint associated with the vacuum generation consists of producing the small cylindrical housing for accommodating the cartridge. The cartridge of the invention can be used as it stands for blowing air. It is also possible to transform this cartridge so as to be able to use it for aspirating air. It then suffices to provide a second orifice for aspirating air inside the cartridge; in this way the cost of the integration for the user is reduced.

In addition a sucker gripping device is proposed, comprising a pneumatic cartridge suitable for aspirating air as previously mentioned, the device comprising a body in which a housing is provided for accommodating the cartridge, a compressed-air inlet pipe emerging in the accommodation housing, a vacuum chamber that emerges in the accommodating housing and which is put in pneumatic communication with at least one sucker, and sealing means for preventing any circulation of air between the inlet pipe and the vacuum chamber through accommodating housing outside the cartridge, the device being arranged so that:
the first lateral orifice of the cartridge is in pneumatic communication with the inlet pipe;
a second lateral orifice of the second chamber of the cartridge that is in pneumatic communication with the vacuum chamber;
the device is controlled by external control means via the electrical connection means of the cartridge.

### BRIEF DESCRIPTION OF THE DRAWINGS

Reference will be made to the accompanying drawings, among which:

FIG. 1 depicts schematically a view in cross section of a cartridge according to a first embodiment of the invention, the cartridge being arranged so as to be normally closed, a cutoff valve of the cartridge being in the closed position;

FIG. 2 depicts schematically a view in cross section of the cartridge according to the first embodiment, the cutoff valve of the cartridge being in the open position;

FIG. 3 depicts schematically a view in cross section of the cartridge according to a variant of the first embodiment, the cartridge being arranged so as to be normally open, the cutoff valve of the cartridge being in the open position;

FIG. 4 depicts schematically a view in cross section of the cartridge according to this variant of the first embodiment, the cutoff valve of the cartridge being in the closed position;

FIG. 5 depicts a perspective view of the cartridge according to a second embodiment of the invention, a cutoff valve of the cartridge being in the closed position;

FIG. 6 depicts a view in perspective of the cartridge according to the second embodiment, a cutoff valve of the cartridge being in the open position;

FIG. 7 depicts a perspective view of a cartridge Of the invention according to the second embodiment suitable for blowing air;

FIG. 8 depicts schematically a view in cross section of the Cartridge according to a third embodiment;

FIG. 9 depicts a view in cross section of the cartridge according to a fourth embodiment, a first control module and a second vacuum generation module of the cartridge being associated;

FIG. 10 depicts a lateral view similar to the view in FIG. 9;

FIG. 11 depicts a lateral view of the cartridge according to the fourth embodiment, the cartridge here consisting of the single first control module;

FIG. 12 is a perspective view similar to the view in FIG. 11;

FIG. 13 depicts a lateral view of the cartridge according to the fourth embodiment, said cartridge here consisting of the second vacuum-generation module and a pneumatic interface;

FIG. 14 depicts a sucker gripping device of the invention.

### DETAILED DESCRIPTION OF THE INVENTION

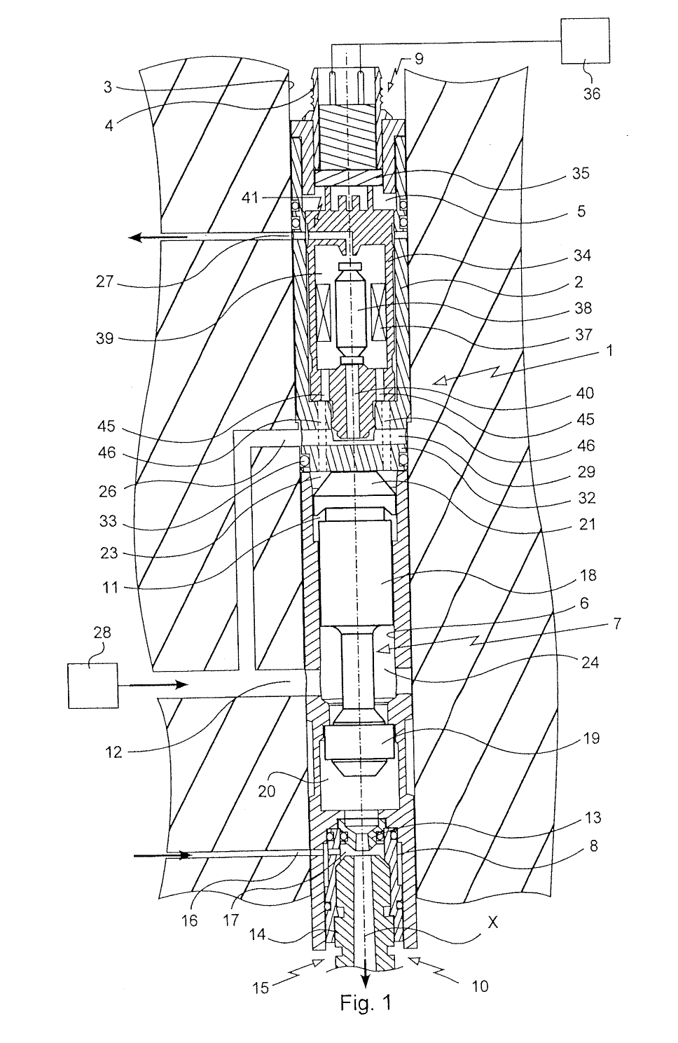

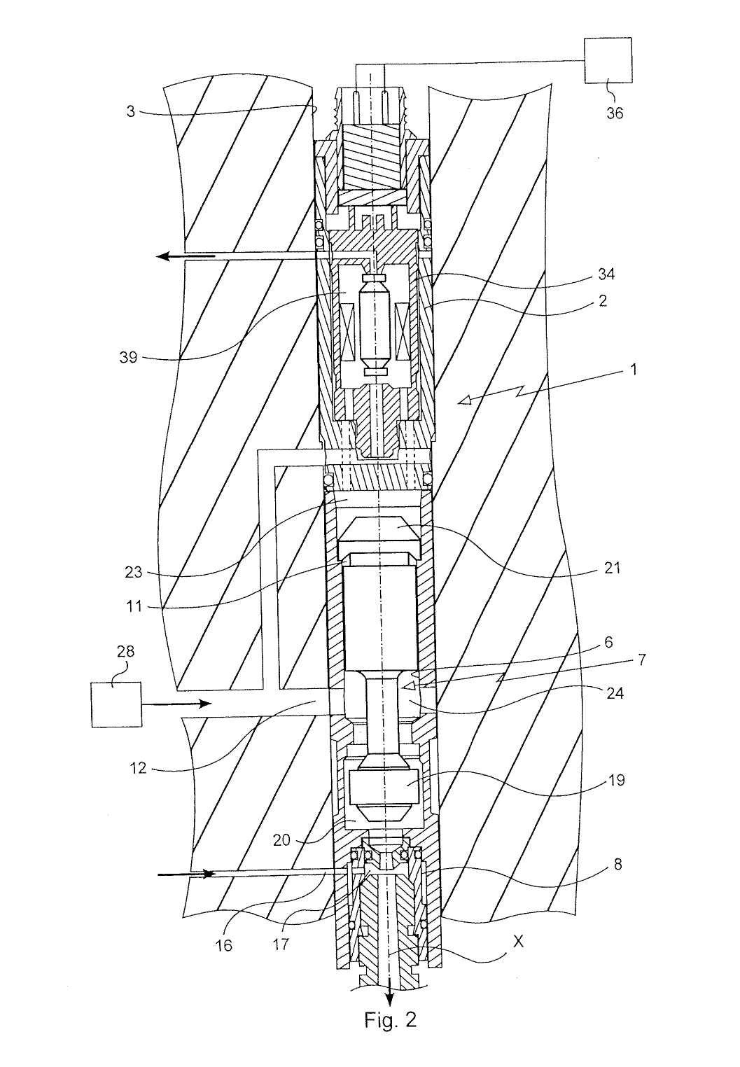

With reference to FIGS. 1 and 2, the cartridge 1 for a pneumatic circuit of the invention according to the first embodiment comprises a tubular body 2 having a cylindrical external surface. The tubular body 2 of the cartridge 1 is here inserted in a cylindrical housing 3 of any vacuum generator.

Inside this tubular body 2 the following are integrated coaxially with one another along an axis X of the tubular body 2: electrical connection means 4, a control enclosure 5 comprising a control means, a first chamber 6 in which a first cutoff valve 7 is arranged, and a second chamber 8 comprising vacuum-generation means.

The electrical connection means 4 are situated at a first end 9 of the tubular body and the second chamber at a second end 10 of the tubular body 2.

The cartridge 1 of the invention is here suitable for generating vacuum by virtue of the vacuum-generation means of the second chamber 8, which function according to the venturi effect. The vacuum-generation means comprise a nozzle 13 attached in the second chamber 8. Said nozzle 13 has an end emerging in the first chamber 6 and opposite an end emerging in the second chamber 8 opposite an end of a mixer 14 coaxial with the nozzle 13. Inside the second chamber 8, the vacuum-generation means form, between the nozzle 13 and the exchanger 14, an annular negative-pressure space 17. The mixer 14 extends in the second chamber 8 and extends in a discharge opening 15 of the second chamber 8 situated at the second end 10 of the tubular body 2 so that the mixer 14 has an open end disposed outside the body 2. The arrows depicted in thick lines in the figures indicate that it is an air inlet or an air outlet.

A first lateral orifice 12 is provided in the body 2 opposite the first chamber 6 to allow an admission of compressed air into the first chamber 6.

The body 2 is provided with a second lateral orifice 16 emerging inside the annular negative-pressure space 17 in order to put the latter in communication with the outside of the body 2.

The compressed air flows from the first chamber 6 to the second chamber 8 through the nozzle 13 while increasing its speed, which creates a negative pressure in the annular negative-pressure space 17, said negative pressure causing an aspiration of air at the second lateral orifice 16. The compressed air and the aspirated air are then discharged from the cartridge through the mixer 14.

The first cutoff valve 7 of the first chamber 6 is used to control this generation of vacuum or on the other hand to interrupt it. The first cutoff valve 7 is thus suitable for allowing or preventing the passage of compressed air from the first chamber 6 to the second chamber 8.

The first cutoff valve 7 is a two-position valve, normally closed, with a stable state corresponding to the closing off of the communication between the first chamber 6 and the second chamber 8.

The first cutoff valve 7 comprises a first shutter 18 having a blocking end 19. The first shutter 18 slides along the axis of the body 2 between en open position, visible in FIG. 1, in which a first communication channel 20 suitable for putting the first chamber 6 and the second chamber 8 in pneumatic communication is left clear, and a closure position, in which the blocking end 19 closes off said communication channel 20. The first shutter 18 also comprises a control end 21. The first shutter defines, inside the first chamber 6, a first control space 23 situated on the same side as the control enclosure 5, a second control space 24 situated on the same side as the second chamber 8, and an intermediate space 11 put in communication with the outside in order to be continuously under atmospheric pressure. The role of these spaces will be explained later.

When the first cutoff valve 7 is in its stable state, that is to say in the closed position, the communication channel 20 is closed off, the compressed air cannot reach the second chamber 8 and the cartridge 1 does not generate any vacuum. On the other hand, When the first cutoff valve 7 is in the open position, the first chamber 6 and the second chamber 8 are in pneumatic communication, which makes it possible to generate vacuum.

The first cutoff valve 7 is controlled by the control means of the control enclosure 5 and by means of the first lateral orifice 12 of the first chamber 6, a control orifice 26 and a first exhaust orifice 27 emerging outside the cartridge 1.

The control orifice 26 is here connected pneumatically to compressed-air supply means 28, just like the first lateral orifice 12. The control orifice 26 emerges in a control chamber 29 situated between the control enclosure 5 and an annular fixed body 32 provided with a seal 33, said annular fixed body 32 having a first face opposite the control chamber 29 and a second face opposite the first chamber 6. The first exhaust orifice 27 is here situated in the control enclosure 5 in the vicinity of the electrical connection means 4.

The control means for their part comprise a control valve 34, in this case a control solenoid valve, as well as an electrical card 35 electrically connected to the electrical connection means 4.

The first cutoff valve 7 is controlled by external control means 36, depicted schematically in FIG. 1, Which transmit a supply voltage and electrical control signals to the electrical card 35 via the electrical connection means 4. The electrical card 35 and control solenoid valve 34 are supplied electrically by the supply voltage. The electrical control signals are shaped by the electrical card 35 and used to generate a control current circulating in an electrical coil 37 of the control solenoid valve 34, said control current being transmitted to the electrical coil 37 when opening of the first cutoff valve 7 and therefore vacuum generation are demanded by the external control means 36.

The circulation of the Control current in the coil 37 makes it possible to move a magnetic core 38 situated in an internal chamber 39 of the control solenoid valve 34 between an idle position and an active position. When the core 38 is in its idle position, it blocks a first end of a central pipe 40, the other end of said central pipe 40 emerging in the control chamber 29. When the core is in its active position, it blocks a second exhaust pipe 41 of the internal chamber of the control solenoid valve, in pneumatic communication with the first exhaust pipe 27.

When the core 33 is in its idle position, visible in FIG. 1, the compressed air fills the second control space 24 of the first chamber 6, by flowing through the first lateral orifice 12, and the control chamber 29 via the control orifice 26. The first control space 23, for its part, is not filled with compressed air. The second control space 24 is therefore raised to a pressure higher than that of the first control space 23, which has the effect of producing a force on the first shutter 18, which tends to move its control end 21 closer to the annular fixed body 32 and to bring its blocking end 19 into the position in which it closes off the first communication channel 20: the first shutter 18 is therefore positioned in the closure position and the first cutoff valve 7 in the closed position. The compressed air therefore does not reach the second chamber 8. The residual compressed it situated in the internal chamber 39 of the control solenoid valve 34 is discharged through the second exhaust orifice 41 and through the first exhaust orifice 27.

When the core 38 is in its active position, visible in FIG. 2, the compressed air in the control chamber fills the internal chamber 39 of the control solenoid valve 34 by flowing via the control chamber 29 and the central pipe 40. As the second exhaust pipe 41 is blocked, the compressed air contained in the internal chamber 39 of the control solenoid valve 34 flows towards the first control space 23 of the first chamber 6 through two first eccentric pipes 45 of the control solenoid valve 34 each communicating with an eccentric tube 46 having an end emerging opposite the associated first eccentric pipe 45 and an end emerging in the first control space 23 of the first chamber 6. The eccentric tubes 46 therefore pass through the control chamber 29 and the annular fixed body 32.

As the surface area of the control end 21 is greater than that of the blocking end 19, the pressure exerted by the compressed air on the control end 21 is greater than that exerted by the compressed air on the blocking end 19, which has the effect of producing a force on the first shutter 18 that tends to move its blocking end 19 away from the position in which it closes off the first communication channel 20: the first shutter 18 is therefore positioned in the open position and the first cutoff valve 7 in the open position. The compressed air therefore reaches the second chamber 8, and the cartridge 1 generates vacuum.

The cartridge 1 of the invention according to the first embodiment previously described therefore comprises a first cutoff valve that is “normally closed”: its stable state corresponds to a valve in the closed position that does not allow passage of compressed air into the second chamber and therefore the generation of vacuum.

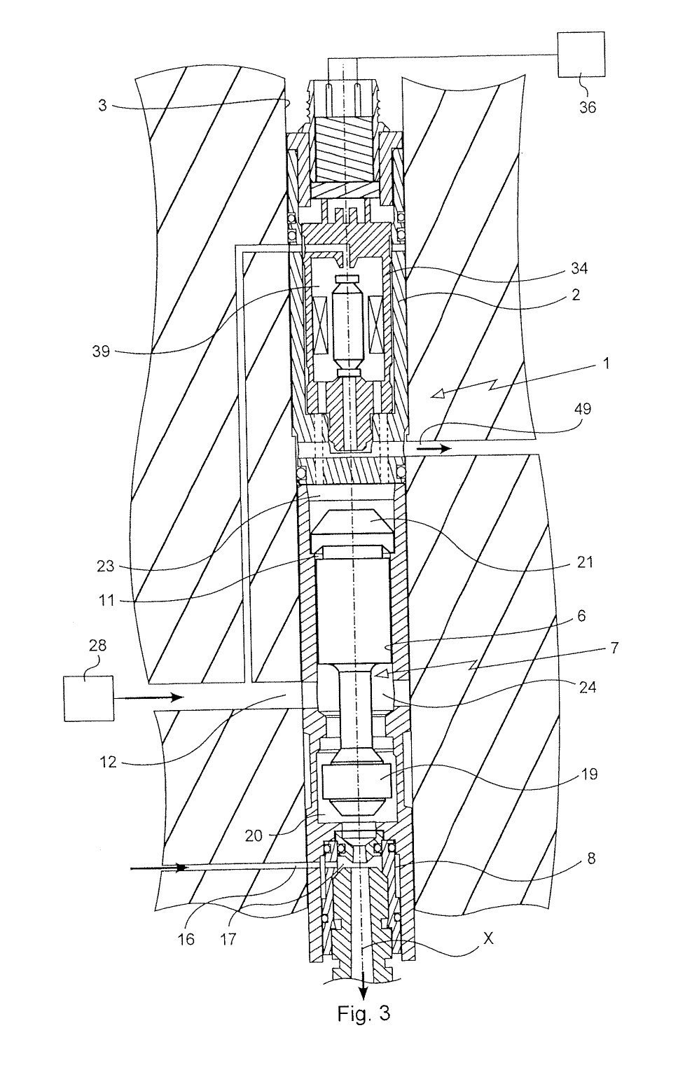

With reference to FIG. 3, the invention can easily be implemented so as to obtain a cartridge that functions with a cutoff valve is “normally open”.

In this variant, the first exhaust orifice 27 is pneumatically connected to the compressed-air supply means 25, just like, the first lateral orifice 12. The control orifice 26 then become a third exhaust orifice 49.

When the core 38 is in its idle position visible in FIG. 3, the compressed air fills the second control space 24 of the first chamber 6 by flowing through the first lateral orifice 12, and the internal chamber 39 of the control solenoid 34 via the first exhaust orifice 27. As the central pipe 40 is blocked, the compressed air fills the first control space 23 of the first chamber 6 via the first eccentric pipes 45 and the eccentric tubes 46. As the surface area of the control end 21 of the cutoff valve 7 is greater than that of the blocking end 19, the pressure exerted by the compressed air on the control end 21 is greater than that exerted by the compressed air on the blocking end 19, which has the effect of producing a force on the first shutter 18 that tends to move its blocking end 19 away from the position in which it closes off the first communication channel: the first shutter 18 is therefore positioned in the opening position and the first cutoff valve 7 in the open position. The compressed air therefore reaches the second chamber 8, and the vacuum cartridge generates vacuum.

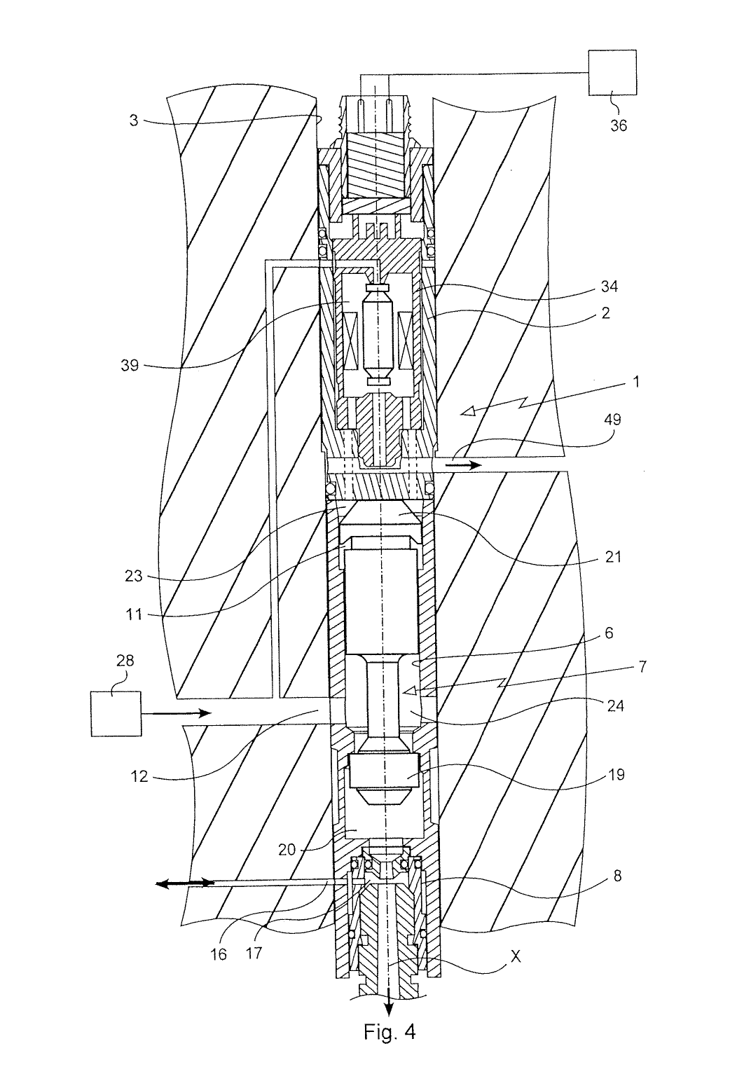

When the core 38 is its active position visible in FIG. 4, the compressed air cannot be introduced into the internal chamber 39 through the second exhaust orifice 41, which is blocked. The compressed air of the first control space 23 of the first chamber 6 flows through eccentric tubes 46 and first eccentric pipes 45 into the internal chamber 39 of the control solenoid 34, and then through the central pipe 40 as far as the control chamber 29, from which it is discharged through the third exhaust orifice 49. The pressure in the second control space 24 of the first chamber 6 therefore becomes greater : than that in the first control space 23, which tends to bring the blocking end 19 of the first shutter 18 into the position in which it closes off the first communication channel 20: the first shutter 18 is therefore positioned in the closure position and the first cutoff valve 7 in the closed position.

It should be noted here that the control solenoid valve of the cartridge of the invention according to the first embodiment visible in FIGS. 1 to 4 has functioning of a valve of the type with three orifices and two positions.

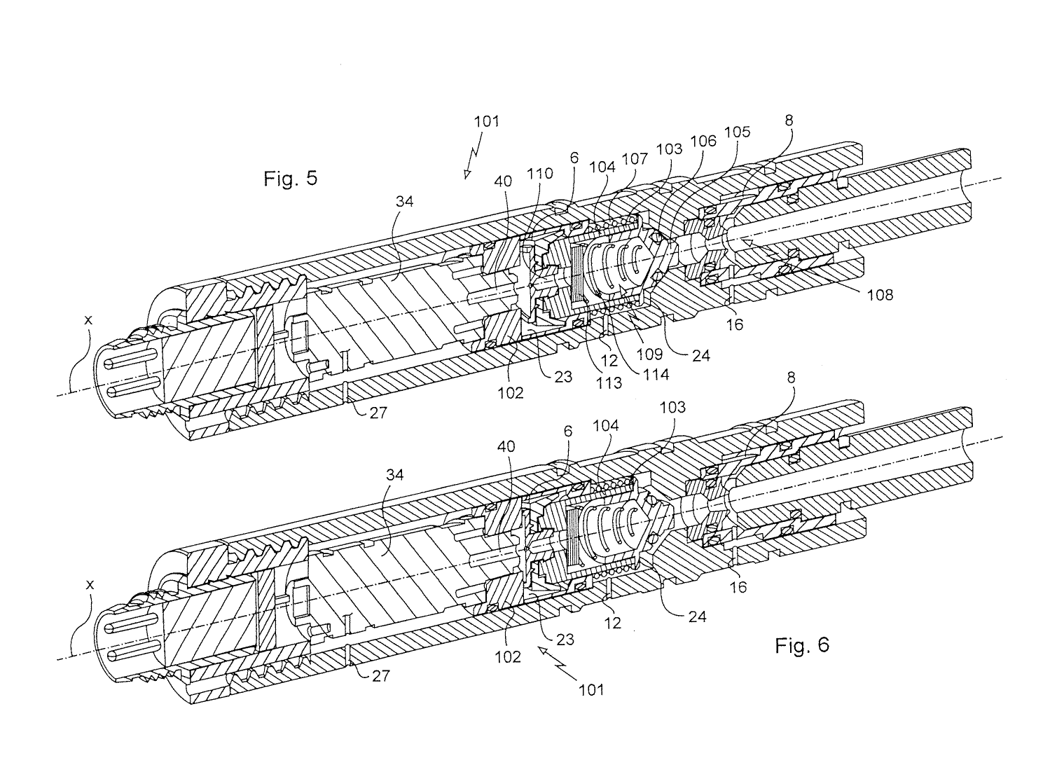

In a second embodiment visible in FIGS. 5 and 6, the cartridge of the invention is equipped with a control solenoid valve having functioning of a valve of the type with two orifices and two positions.

The cartridge of the invention 101 according to the second embodiment comprises a certain number of elements similar to those described previously for the first embodiment and the references of which are kept in FIGS. 5 and 6.

A certain number of differences between the two embodiments are all the same noted. In the second embodiment, the first eccentric pipes of the control solenoid valve 34 are blocked and unused. In addition, the cartridge 101 does not have a control chamber: the central pipe 40 of the control solenoid valve 34 emerges in the first chamber 6, said central ripe 40 here passing through a second annular fixed body 102. It should also be noted that the cartridge 101 no longer has any control orifice. It should also be noted that the cutoff valve is a second cutoff valve 103 different from the first cutoff valve of the first embodiment. The second cutoff valve 103 comprises a second sliding shutter 104 comprising a blocking end 105 provided with a seal 106, and a compression spring 107.

The second shutter 104 slides between an opening position, visible in FIG. 5, in which a second communication channel 108 suitable for putting the first chamber 6 and the second chamber 8 in pneumatic communication is left clear, and a closure position, in which the blocking end 105 closes off said channel 108. The compression spring 107 tends to hold the second cutoff valve 103 in the closed position, which is its stable state. The second shutter 104 is hollow and once again defines in the first chamber the first control space 23 in which the central pipe 40 of the control solenoid valve 34 emerges, and the second control space 24.

An internal space 109 and a leakage channel 110 are defined inside the second shutter 104. A filter 113 and a spring 114, frustoconical in shape, are arranged in the internal space 109, so that the spring 114 holds the filter 113 in position facing and in the immediate vicinity of the leakage channel 110. The leakage channel 110 makes it possible to put the first control space 23 and the second control space 24 in pneumatic communication. The compressed air therefore flows from the second control space 24 into the first control space 23 through the leakage channel 110, passing through the filter 113, which purifies the compressed air so as to prevent impurities blocking the leakage channel 110.

The functioning of the cartridge 101 according to the second embodiment is now described.

The idle position of the control core 38 of the control solenoid valve 34 once again corresponds to a new position in which it blocks the central pipe 40, and the active position to a position in which it blocks the second exhaust orifice 41.

Thus, when the control core 38 is in the idle position visible, in FIG. 5, the compressed air admitted by the first lateral orifice 12 fills the second control Space 24 Of the first chamber 6, the internal space 109 if the second shutter 104 and the first control space 23 via the leakage channel 110. As relatively similar pressures are thus exerted on the surfaces of the second shutter 104 situated in the first space 23 and in the second space 24, and by virtue of a compression force exerted by the compressions spring 107, the blocking end 105 of the second shutter 104 closes off the second communication channel 108 and the second cutoff valve 103 is in the closed position.

When the control core 38 is in the active position visible in FIG. 6, the compressed air contained in the first control space 23 escapes therefrom through the central pipe 40 of the control solenoid valve 34, and is discharged from the cartridge 101 through the second exhaust orifice 41 and the first exhaust orifice 27. The pressure exerted by the compressed air on the surface of the second shutter 104 situated in the second control space 24 is thus greater than the compression force exerted by the compression spring 107: the blocking end 105 of the second shutter 104 moves away from the second communication channel and the second cutoff valve 103 is in the open position.

It should be noted that the cartridge according to the second embodiment depicted in FIGS. 5 and 6 comprises a second cutoff valve that is “normally closed”. By modifying the control solenoid valve, it is perfectly possible to replace the second cutoff valve with a “normally open” cutoff valve.

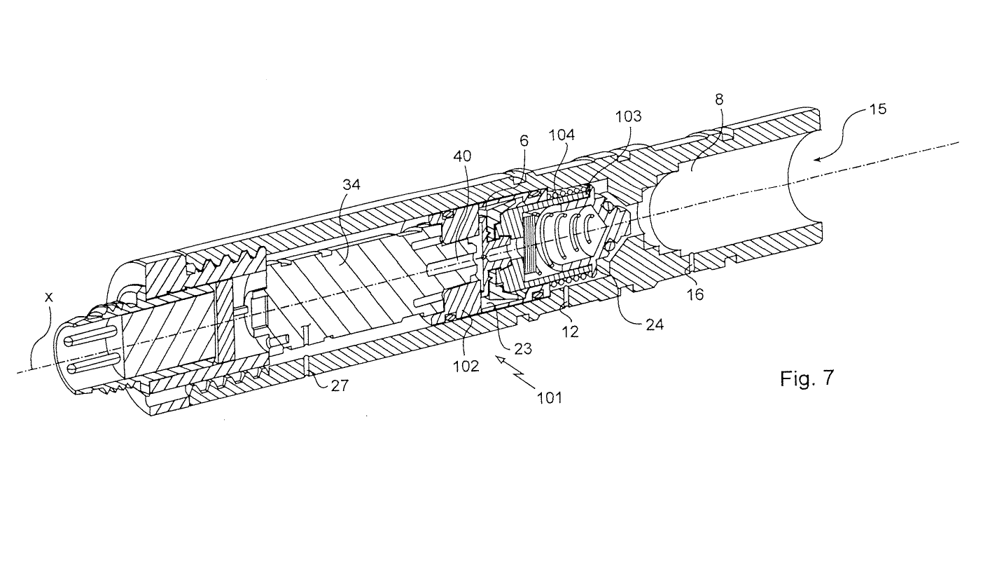

It should be noted here that the cartridge 1 described in the first embodiment of the invention and the cartridge 101 described in the second embodiment of the invention are cartridges suitable for generating vacuum. With reference to FIG. 7, it is however observed that, if the second chamber 8 is removed from the vacuum generation means, in this case the nozzle 13 and the mixer 14, a cartridge 101 suitable for blowing air through the discharge opening 15 of the second chamber 8 is obtained. The second lateral orifice 16 is then either blocked, or positioned opposite a surface closing off said second lateral orifice. This may of course also be achieved on a cartridge according to the first embodiment of the invention.

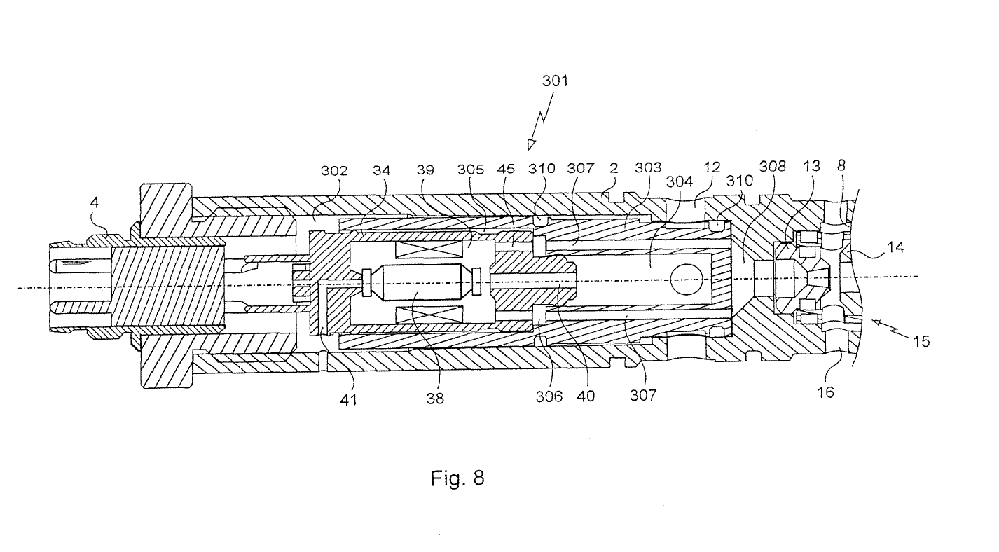

In a third embodiment visible in FIG. 8, the cartridge, of the invention 304 this time no longer has a cutoff valve: the control means are suitable not only for selectively controlling but also for putting a first and second chamber in pneumatic communication so as to allow a passage of air to the second chamber.

Just like the cartridges described earlier, the cartridge 301 of the third embodiment comprises a tubular body 2 comprising electrical connection means 4 and a second chamber 8 comprising vacuum-generating means, in this case a nozzle 13 and a mixer 14. A main chamber 302 extends between the electrical connection means 4 and the second chamber 8. A part of revolution constituting a jacket 303 is inserted in the main chamber 302.

Inside the jacket 303 there are defined a first tubular space 304 and a second tubular space 305 coaxial with each other, a control chamber 306, and two second eccentric pipes 307 extending along the first tubular space 304 and emerging at one of their ends in the control chamber 37 and at the other end in a third communication channel 308 suitable for putting the main chamber 302 and the second chamber 8 in pneumatic communication.

The first tubular space 304 defines a first chamber 304 having a role similar to that of the previously described first chambers, said first chamber 304 however not having any cutoff valve.

A control solenoid valve 34, similar to the solenoid valves described above and having the functioning of a valve of the type with three orifices and two positions, is positioned inside the jacket 303.

The control solenoid valve 34 comprises a control core 38 situated in an internal chamber 39, a second exhaust orifice 41, a central pipe 40 emerging in the first tubular space 304 and two first eccentric pipes 45 emerging in the control chamber 306 opposite the second eccentric pipes 307.

Seals 310 are mounted around the jacket 303 between it and an internal surface of the tubular body 2 in order to prevent any passage of air outside the jacket 303 between the first chamber 304 and the second chamber 8, and between the first chamber 304 and the main chamber 302.

Finally, the tubular body 2 comprises a first lateral orifice 12 and a second lateral orifice 16 similar to those previously described.

The functioning of the cartridge according to the third embodiment is now described.

The idle position of the control core 38 of the control solenoid valve 34 corresponds once again to a position in which it blocks the central pipe 40, and the active position to a position in which it blocks the second exhaust orifice 41.

Thus, when the control core 38 is in the idle position, the compressed air admitted by the first lateral orifice 12 fills the first chamber and remains inside it. Any residual compressed air situated in the internal chamber 39 of the control solenoid 34 is discharged by the second discharge orifice 41.

When the control core 38 is in the active position visible in FIG. 8, the compressed air fills the internal chamber 39 via the central pipe 40 and reaches the second chamber of the cartridge via the two first eccentric pipes 45, the control chamber 306, the two second eccentric pipes 307 and the third communication channel 308. The compressed air therefore reaches the second chamber 8, and the vacuum cartridge generates vacuum.

It can be seen once again that, if the vacuum generating means are removed from the second chamber 8, a cartridge 101 suitable for blowing air through the discharge opening 15 of the second chamber 8 is obtained.

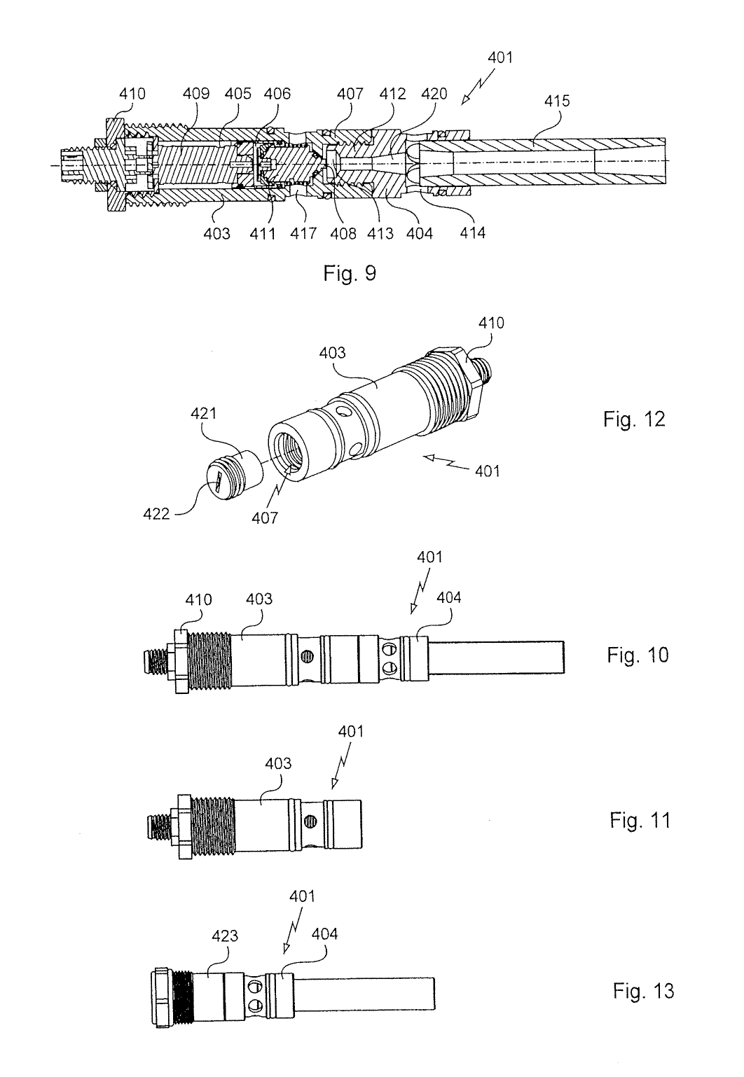

In a fourth embodiment visible in FIGS. 9 to 13, the cartridge, of the invention 401 is a configurable cartridge relatively similar structurally to the cartridge of the invention 101 according to the second embodiment, but which has the particularity of being able to be configured so as to selectively fulfill various functions.

The cartridge 401 comprises a first module 403 and a second module 404 that can be separated.

The first module 403 is a control module, inside which there are defined a control enclosure 405, a first chamber 406, a first lateral orifice 417, and a tapped hollow end 407 separated from the first chamber 406 by a third communication channel 408. The control enclosure 405 comprises a control solenoid valve 409 similar to the control solenoid valve 34 and suitable for controlling a cutoff valve 411 arranged in the first chamber 406. Electrical connection means 410 similar to those of the other embodiments are arranged on the first module 403.

The second module 404 is a vacuum-generating module comprising a threaded end 412 and inside which there are defined a nozzle 413, a second lateral orifice 414 and a mixer 415 coaxial with the nozzle 413.

In a first configuration visible in FIGS. 9 and 10, the second module 404 is secured to the first module 403 by screwing of the threaded end 412 in the tapped hollow end 407. The cartridge 401 is then suitable for being controlled via the electrical connection means 410 in order to selectively generate vacuum. The control solenoid valve 409 controls the cutoff valve 411 so that the latter allows an admission of compressed air via the first lateral orifice 417. The compressed air flows through the nozzle 413 and generates an aspiration of air at the second lateral orifice 414. It should be noted here that, just like the other embodiments, the cartridge 401 defines a second chamber 420, which extends here partly inside the threaded and 412 and partly inside the second module 404.

In a second configuration visible in FIGS. 11 and 12, the first module 403 functions autonomously, without being associated with the second module 404. The cartridge 401 no longer comprises vacuum-generating means and is suitable for blowing air through the tapped hollow end 407. Provision is made for screwing, inside the tapped hollow end 407, a regulating connecting piece 421 comprising a regulation orifice 422 and making it possible to regulate the flow of air blown by the cartridge 401.

Finally, in a third configuration visible in FIG. 13, the second module 404 is once again used for generating vacuum, but is not associated with the first module 403. The second module 404 is screwed inside a pneumatic interface 423 suitable for being connected directly to a compressed-air inlet. In this third configuration, the cartridge 401 is no longer controlled electrically: it makes it possible solely to generate vacuum from compressed air when the compressed air passes through the cartridge 404 via the pneumatic interface 423.

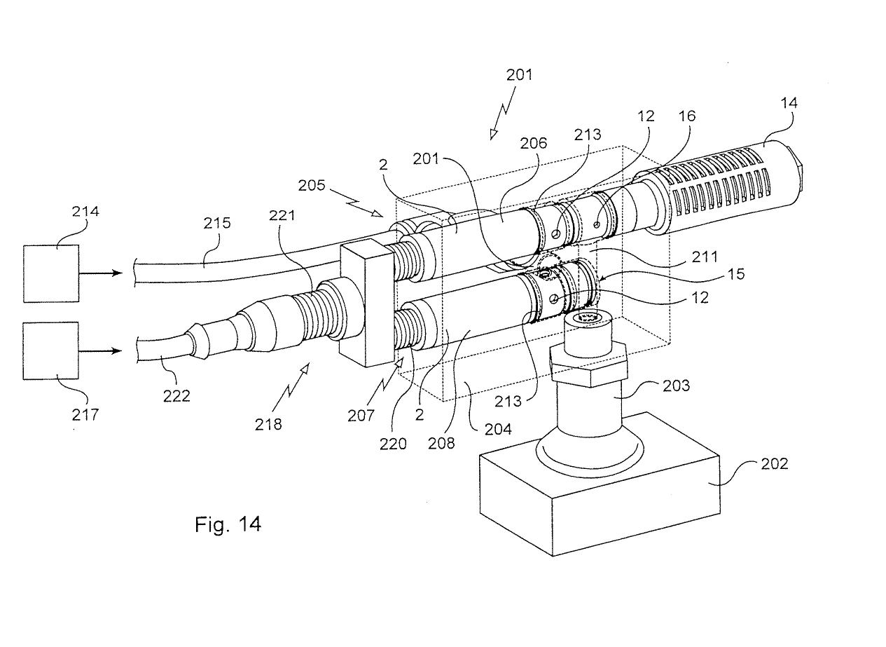

A sucker gripping device 201 of the invention, visible in FIG. 14, is now described. The gripping device 201 is intended to perform a manipulation or gripping of a product 202 having a surface on which a sucker 203 is applied. For this purpose, the gripping device 201 of the invention is here suitable for aspirating air contained in the sucker 203 when the manipulation or gripping is demanded, or to blow air inside the sucker 203 when the manipulation or gripping has ended and it is wished to disconnect the sucker from the surface of the product 202.

The gripping device of the invention comprises a main body 204 in which a first cylindrical housing 205 is provided for accommodating a first cartridge 206 according to the first or second embodiment and suitable for aspirating air, and a second cylindrical housing 207 for accommodating a second cartridge 208 according to the first or second embodiment and suitable for blowing air.

The first and second cartridges 206, 203 are introduced into their respective cylindrical housings in an axial direction corresponding to the axis X of the tubular body with a cylindrical surface of each cartridge.

The device also comprises a compressed-air inlet pipe 210 emerging in the first cylindrical housing 205 and in the second cylindrical housing 207, a vacuum chamber 211 that emerges in the first cylindrical housing 205 and in the second cylindrical housing 207 and which is put in pneumatic communication with the inside of the sucker 203. The gripping device also comprises sealing means for preventing any flow of air between the admission pipe 210 and the vacuum chamber 211 through the first and second cylindrical housings 205, 207 and outside respectively the first and second cartridges 205, 208. The sealing means, are here annular gaskets 213 mounted on the tubular body of the first and second cartridges.

The gripping device is connected pneumatically to pneumatic supply means 214 via a pneumatic connection pipe 215 that emerges sealingly in the compressed-air admission pipe 210.

The first lateral orifice 12 of the first cartridge 206 and the first lateral orifice 12 of the second cartridge 208 are in pneumatic communication with the admission pipe 210. The second lateral orifice 16 of the first cartridge 206 and the discharge orifice 15 of the second cartridge are in pneumatic communication with the vacuum chamber.

It should be noted here that this arrangement is allowed in particular by the fact that the tubular body 2 of the second cartridge 206 is less long than that of the first cartridge 208.

The electrical connection means 4 of the first cartridge 206 and the electrical connection means 4 of the second cartridge 208 are electrically connected to external control means 217 via a common electrical connector 218 of the “T connector” type of the gripping device 201. The connector 218 has two first connection elements 220 each connected to the electrical connection means 4 of one of the cartridges and a second connection element 221 connected to an electrical cable 222 connected to the external control means 217. The use of this common connector 218 therefore makes it possible to supply and control the electrical cards and the control solenoid valves of the first and second cartridges using a single electrical cable 222, which has an obvious advantage in terms of bulk, weight and cost of the device.

The functioning of the gripping device of the invention is now described.

The admission pipe 210 is constantly filled with compressed air supplied by the pneumatic supply means 214.

When the external control means 217 demand an aspiration of air, the cutoff valve of the first cartridge 206 is opened, and therefore the first cartridge 206 aspirates the air contained in the vacuum chamber 211 and therefore in the internal space of the sucker 203, which is then secured to the product 202. The compressed air and the aspirated air are discharged from the gripping device 201 via a mixer 14 introduced into the first cartridge 206. The cutoff valve of the second cartridge 208 for its part is closed.

When the external control means demand a blowing of air for disconnecting the sucker from the surface of the product, the cutoff valve of the first cartridge 206 is closed and the cutoff valve of the second cartridge 208 is opened. The second cartridge 208 blows compressed air into the vacuum chamber 211, which fills the inside of the sucker 203 with air and causes the disconnection of the product 202 from the sucker 203.

The invention is not limited to the particular embodiments that have just been described but quite the contrary covers any variant falling within the scope of the invention as defined by the claims.

Although a sucker gripping device, has been described in detail, the cartridge for a pneumatic circuit of the invention can of course be used in different applications, for example in a pneumatic directional control valve.

1. A cartridge for a pneumatic circuit comprising a tubular body having a cylindrical surface enabling it to be inserted in a cylindrical housing in an axial direction (X), the cartridge being such that, in said tubular body, the following are integrated coaxially with one another:
electrical connection means situated at a first end of the tubular body;
control means supplied and controlled via the electrical connection means;
a first chamber comprising a first lateral orifice for admitting compressed air;
at least a second chamber situated at a second end of the tubular body and comprising an air outlet orifice;
the control means being suitable for selectively putting the first chamber and the second chamber in pneumatic communication so as to allow passage of air to the second chamber.

2. The cartridge for a pneumatic circuit according to claim 1, in which the first chamber comprises a cutoff valve controlled by the control means.

3. The cartridge according to claim 1, in which the second chamber comprises vacuum-generating means, and in which the second chamber comprises a second lateral orifice used for aspirating air.

4. The cartridge according to claim 3, in which the vacuum-generating means function according to the venturi effect, in which the second chamber comprises a nozzle emerging in the first chamber and in the second chamber, and in which a mixer coaxial with the nozzle extends partially in the second chamber in the vicinity of the second lateral orifice.

5. The cartridge according to claim 4, in which the nozzle is attached in the second chamber.

6. The cartridge according to claim 1, in which a second lateral orifice of the second chamber is used to blow air.

7. The cartridge according to claim 1, in which the control means comprise a control valve of the type with two orifices and two positions or of the type with three orifices and two positions.

8. The cartridge according to claim 7, in which the control valve is a solenoid valve.

9. The cartridge according to claim 1, in which the control means comprise an electrical control card connected to the electrical connection means.

10. The cartridge according to claim 1, comprising a first control module and a second vacuum-generating module that can be separated, the cartridge being such that, when the first module and the second module are associated, the cartridge is suitable for being controlled via the electrical connection means in order to selectively generate vacuum.

11. The cartridge according to claim 10, in which the first module comprises the control means, the electrical connection means and the first chamber, and in which vacuum-generating means are arranged in the second module.

12. The cartridge according to claim 10, in which, when the second module is separated from the cartridge, the cartridge is suitable for blowing air and the first module is suitable for being associated with a regulating connection piece for regulating the flow of air blown by the cartridge.

13. The cartridge according to claim 10, in which, when the first module is separated from the cartridge, the cartridge is suitable for generating vacuum and the second module is suitable for being associated with a pneumatic interface for directly connecting a compressed-air inlet to the cartridge.

14. The sucker gripping device, comprising a cartridge according to claim 1 and suitable for generating vacuum, the device comprising a body in which a housing is provided for accommodating the cartridge, a compressed-air inlet pipe emerging in the housing, a vacuum chamber that emerges in the accommodating housing and which is put in pneumatic communication with at least one sucker, and sealing means for preventing any circulation of air between the inlet pipe and the vacuum chamber through the accommodating housing outside the cartridge, the device being arranged so that:
the first lateral orifice of the cartridge is in pneumatic communication with the inlet pipe;
a second lateral orifice of the second chamber of the cartridge that is in pneumatic communication with the vacuum chamber;
the device is controlled by external control means via the electrical connection means of the cartridge.

15. The sucker gripping device according to claim 10, in which the sealing means are mounted on the tubular body of the cartridge.

16. The sucker gripping device according to claim 11, equipped with a first cartridge and suitable for generating vacuum, and a second cartridge suitable for blowing air, the first cartridge being intended to aspirate air from the vacuum chamber in order to grip an object on which the sucker is applied, and the second cartridge being intended to blow air into the vacuum chamber in order to separate the object and the sucker.

17. The sucker gripping device according to claim 16, comprising a common electrical connector to which the electrical connection means of the first cartridge and of the second cartridge are connected, the gripping device being connected to the external control means via this common collector.
